(19) United States
(12) Patent Application Publication
(10) Pub. No.: US 2016/0121693 A1
(43) Pub. Date: May 5, 2016

(54) AIR EXTRACTOR GRILLE

(71) Applicant: Hyundai Motor Company, Seoul (KR)

(72) Inventors: Myung Hoe KIM, Seoul (KR); II Ju SEO, Seoul (KR); In Gyu KIM, Hwaseong-Si (KR); Ho Duck LEE, Ansan-Si (KR)

(73) Assignee: Hyundai Motor Company, Seoul (KR)

(21) Appl. No.: 14/563,295

(22) Filed: Dec. 8, 2014

(30) Foreign Application Priority Data
Nov. 4, 2014 (KR) 10-2014-0152330

(51) Int. Cl. B60H 1/26

(52) U.S. Cl. CPC B60H 1/26

(57) ABSTRACT

An air extractor grille may include a housing having a plurality of vent holes and fastening holes, a valve panel configured to cover the vent holes and have coupling holes formed at positions corresponding to the fastening holes, and a fastening section, wherein end portions of the fastening section pass through the coupling holes and the fastening holes to be integrally coupled to the housing and the valve panel while another end portion thereof comes into contact with the housing and the valve panel at an outer side of the valve panel to cover a gap between the housing and the valve panel.

### CROSS-REFERENCE(S) TO RELATED APPLICATIONS

The present application claims priority of Korean Patent Application Number 10-2014-0152330 filed on Nov. 4, 2014, the entire contents of which application are incorporated herein for all purposes by this reference.

### BACKGROUND OF THE INVENTION

1. Field of the Invention

The present invention relates to an air extractor grille; and, particularly, to an air extractor grille for preventing introduction of exhaust gas and dust from the outside of a vehicle.

2. Description of Related Art

An air extractor grille is a device which maintains an interior of a vehicle in a comfortable state by preventing exhaust gas and dust from being introduced into the interior of the vehicle from the outside thereof and, on the contrary, discharging foreign substances in the vehicle to the outside.

FIG. 1 is a view illustrating a conventional air extractor grille. The conventional air extractor grille includes a frame 10 coupled to a vehicle body and a plurality of flaps 20 installed to the frame 10 to close a plurality of vent holes formed at the frame, and each of the flaps 20 is provided with a fastening protrusion 21 fitted to the frame 10.

However, the conventional configuration has a problem in that a gap is generated between the fastening protrusion 21 and the frame 10 since the fastening protrusion 21 is fitted to the frame 10 and thus foreign substances such as dust and exhaust gas are introduced into an interior of a vehicle.

The matters described as the related art have been provided only for assisting the understanding for the background of the present invention and should not be considered as corresponding to the related art already known to those skilled in the art.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an air extractor grille for sealing a gap between a flap and a frame so as not to introduce foreign substances through the gap between the flap and the frame.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In an aspect of the present invention, an air extractor grille may include a housing having a plurality of vent holes and fastening holes, a valve panel configured to cover the vent holes and may have coupling holes formed at positions corresponding to the fastening holes, and a fastening section, wherein end portions of the fastening section pass through the coupling holes and the fastening holes to be integrally coupled to the housing and the valve panel while another end portion thereof comes into contact with the housing and the valve panel at an outer side of the valve panel to cover a gap between the housing and the valve panel.

A space surrounded by the another end portion of the fastening section and the housing is provided between the another end portion of the fastening section and the housing, and one end of the valve panel is provided with a sealing protrusion, an outer peripheral surface of which comes into contact with an inner peripheral surface of the space while the sealing protrusion is located in the space.

The housing is bent in a zigzag shape to have a dent and a ridge, and the space is formed to be surrounded by the dent and the another end portion of the fastening section.

One end portion of the valve panel is formed with a guide groove, and a guide protrusion engaged with the guide groove is formed at a position corresponding to the guide groove in the housing.

An engagement portion of the guide groove and the guide protrusion is formed in a V-shape.

The housing is bent at a position corresponding to the another end of the valve panel to have a ridge, and another end of the valve panel is provided with a cover protrusion which protrudes to cover the ridge.

The coupling holes are formed at one end portion of the valve panel in a longitudinal direction thereof, and a folded groove is formed between the coupling holes and the another end portion of the valve panel in a width direction of the valve panel such that the another end portion of the valve panel is rotatable.

A hook protrusion is formed on one side surface of each end portion of the fastening section to be hooked to each fastening hole when the hook protrusion is inserted into the fastening hole, and a slope is formed at another side surface of the end portion such that the fastening section is pressed in one direction when the hook protrusion is inserted into the fastening hole.

A groove is formed on at least one of a bonding surface between the another end portion of the fastening section and the housing and a bonding surface between the another end portion of the fastening section and the valve panel.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a configuration of a conventional air extractor grille.

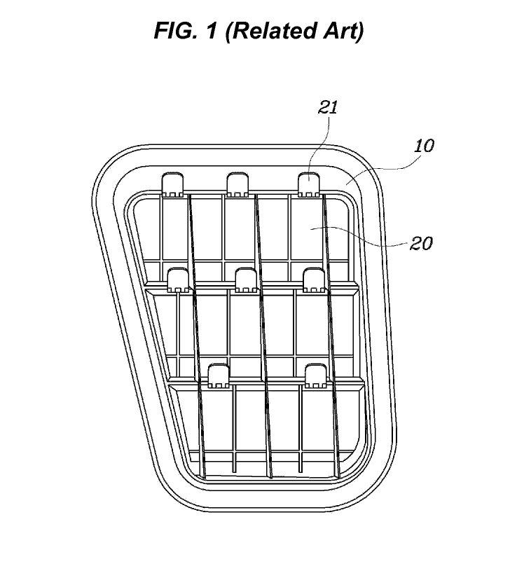

FIG. 2 is an exploded perspective view illustrating an air extractor grille according to an exemplary embodiment of the present invention.

FIG. 3 is a view illustrating a housing of the air extractor grille according to the exemplary embodiment of the present invention.

FIG. 4A and FIG. 4B are views illustrating one valve panel of the air extractor grille according to the exemplary embodiment of the present invention.

FIG. 5 is a view illustrating one fastening section of the air extractor grille according to the exemplary embodiment of the present invention.

FIG. 6 is a side view illustrating the air extractor grille according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF SPECIFIC EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An air extractor grille according to exemplary embodiments of the present invention will be described below in more detail with reference to the accompanying drawings. The present invention may, however, be embodied in different forms and should not be construed as limited to the exemplary embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

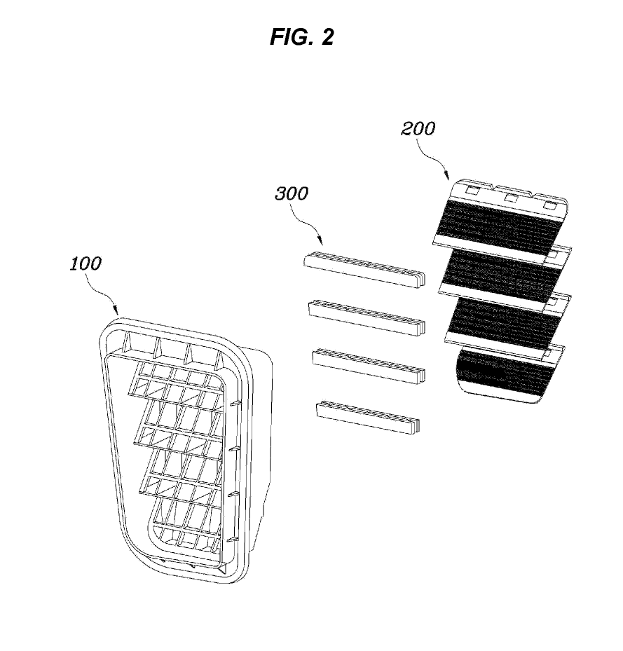

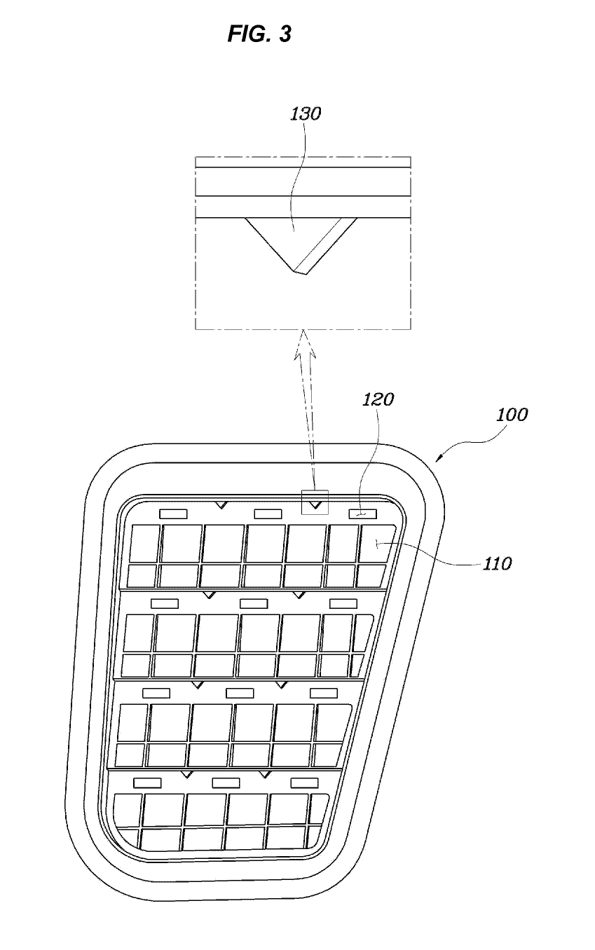

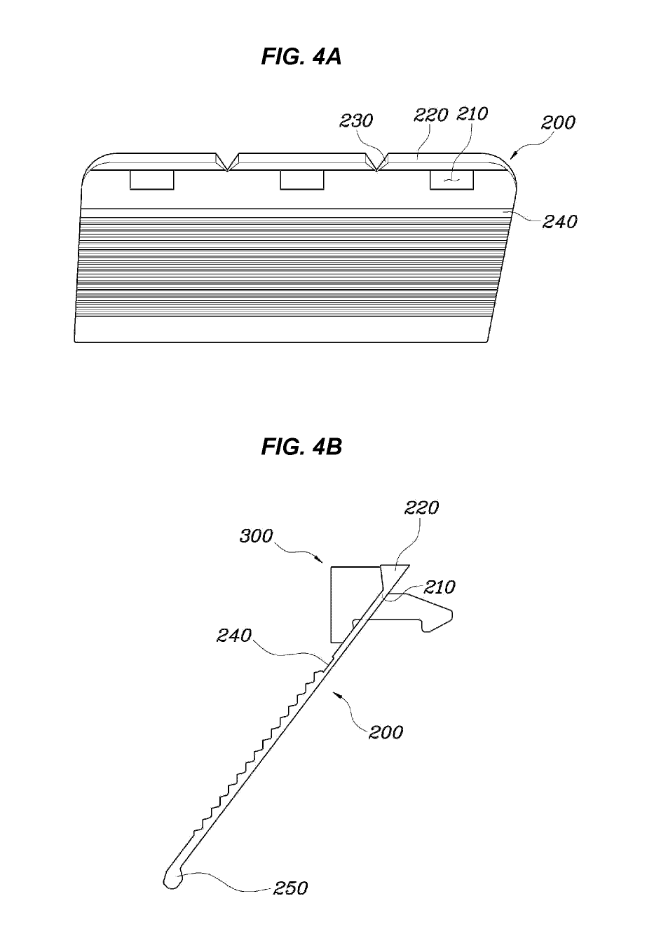

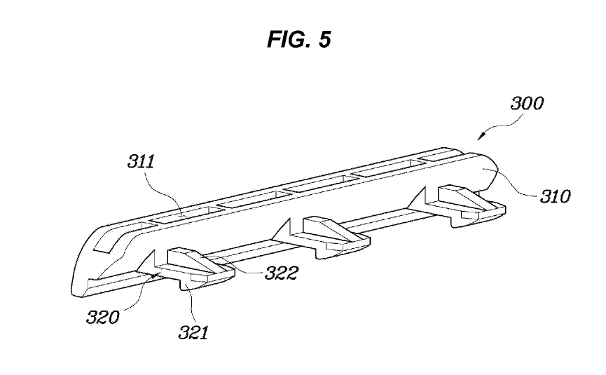

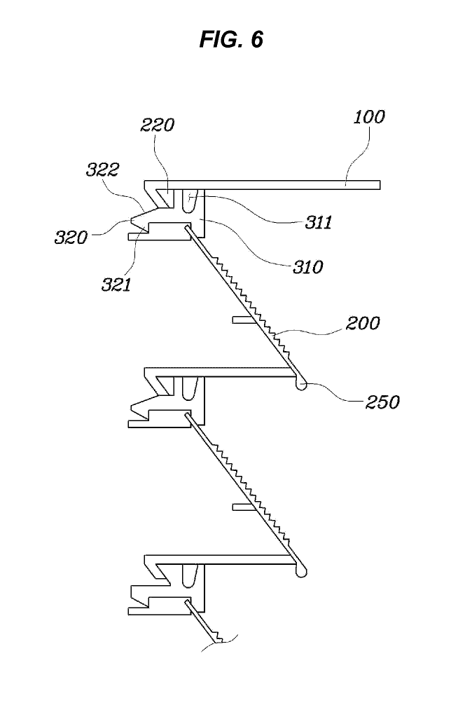

FIG. 2 is an exploded perspective view illustrating an air extractor grille according to an exemplary embodiment of the present invention. FIG. 3 is a view illustrating a housing of the air extractor grille according to the exemplary embodiment of the present invention. FIGS. 4A and 4B are views illustrating one valve panel of the air extractor grille according to the exemplary embodiment of the present invention. FIG. 5 is a view illustrating one fastening section of the air extractor grille according to the exemplary embodiment of the present invention. FIG. 6 is a side view illustrating the air extractor grille according to the exemplary embodiment of the present invention.

As shown in FIG. 2, the air extractor grille according to the exemplary embodiment of the present invention includes a housing 100 having a plurality of vent holes 110 and fastening holes 120, valve panels 200 each configured to cover the vent holes 110 and have coupling holes 210 formed at positions corresponding to the fastening holes 120, and fastening sections 300 each configured such that end portions 320 thereof pass through the associated coupling holes 210 and fastening holes 120 to be integrally coupled to the housing 100 and the associated valve panel 200 while the other end portion 310 thereof comes into contact with the housing 100 and the associated valve panel 200 at an outer side of the valve panel 200 to cover a gap between the housing 100 and the valve panel 200.

The fastening section 300 comes into contact with the housing 100 and the valve panel 200 so as to maintain sealing therebetween. Consequently, containments such as exhaust gas and dust may be prevented from being introduced into an interior of a vehicle through the gap between the housing 100 and the valve panel 200 from the outside, and thus comfortableness of the interior may be enhanced or maintained.

In addition, the end portions 320 of the fastening section 300 pass through the fastening holes 120 and the coupling holes 210 to couple the valve panel 200 to the housing 100, thereby enabling assembly thereof to simply and easily be performed so as to reduce work processes.

Meanwhile, the exemplary embodiment of the present invention will be described in more detail. As shown in FIG. 3, the housing 100 is bent in a zigzag shape to have a plurality of dents and ridges which are formed in a vertical direction, and the plurality of fastening holes 120 and vent holes 110 are preferably formed on any one of one side inclined surface and the other side inclined surface which face each other on the basis of a bent portion constituting each dent in the housing 100. It is assumed that the plurality of fastening holes 120 and vent holes 110 are formed on one side inclined surface in the exemplary embodiment.

In addition, each fastening hole 120 is preferably located closer to the dent of the housing 100 rather than each vent hole 110 so that the vent hole 110 is opened and closed by rotation of the other end portion of the valve panel 200 toward an exterior of the vehicle in a state in which the valve panel 200 is fixed to the housing through the fastening hole 120.

Meanwhile, FIGS. 4A and 4B are views illustrating the valve panel 200. FIG. 4A is a front view of the valve panel 200 and FIG. 4B is a side view of the valve panel 200 coupled to the fastening section 300.

It is preferable that the valve panel 200 is provided at one side inclined surface and the coupling holes 210 are formed at one end portion of the valve panel 20 in a longitudinal direction thereof so that one end portion of the valve panel 200 is fixed to the housing 100 through the fastening section 300 and the fastening holes 120. As shown in FIG. 4A, a folded groove 240 may be formed between the coupling holes 210 and the other end portion of the valve panel 200 in a width direction of the valve panel 200 such that the other end portion of the valve panel 200 is rotatable. As such, one end portion of the valve panel 200 is lifted when the other end portion of the valve panel 200 is rotated so as to be opened toward the exterior of the vehicle, thereby preventing generation of the gap between the housing 100 and the valve panel 200. In addition, inner air and foreign substances may be discharged to the outside since opening force of the valve panel 200 is reduced and thus easily opened. In addition, the valve panel 200 may be further opened by increase of an angle bent by a groove 311, compared to a case in which the groove 311 is not formed.

Meanwhile, a space surrounded by the other end portion 310 of the fastening section 300 and the housing 100 is provided between the other end portion 310 of the fastening section 300 and the housing 100. As shown in FIG. 4B, one end of the valve panel 200 may be provided with a sealing protrusion 220, an outer peripheral surface of which comes into contact with an inner peripheral surface of the space while the sealing protrusion 220 is located in the space.

The space may be formed so as to be surrounded by the dent of the housing 100 and the other end portion 310 of the fastening section 300, and the sealing protrusion 220 may be formed so as to match the shape of the space, thereby improving sealing between the housing 100 and the valve panel 200.

Meanwhile, as shown in FIGS. 3 and 4A, one end portion of the valve panel 200 may be formed with guide grooves 230, and guide protrusions 130 which are engaged with the guide grooves 230 may be formed at positions corresponding to the guide grooves 230 in the housing 100.

An engagement portion of each guide groove 230 and the associated guide protrusion 130 is preferably formed in a V-shape, in order to enable ease engagement and positioning of the valve panel 200 and reliably fix the valve panel 200 to the housing 100 by preventing the valve panel 200 from swinging in the width and longitudinal directions thereof when the valve panel 200 is coupled to the housing 100. Of course, the shape of the engagement portion is not limited to the V-shape, and may be formed in various shapes such as a polygonal shape and a circular shape.

As shown in FIG. 4B, the other end of the valve panel 200 may be provided with a cover protrusion 250 which protrudes to cover the ridge formed by bending of the housing 100.

The other end of the valve panel 200 is provided so as to correspond to the ridge formed by bending of the housing 100. The cover protrusion 250 protrudes to cover the ridge while always coming into contact with the ridge, thereby preventing contaminants from being introduced into the interior of the vehicle from the outside through the gap generated due to the lift of the other end portion of the valve panel 200 from the housing 100 and preventing that the valve panel 200 does not come into close contact with the housing 100 due to deformation of the valve panel 200 caused by factors such as durability problem and deterioration.

In the fastening section 300, as shown in FIG. 5, a hook protrusion 321 may be formed on one side surface of each end portion 320 of the fastening section 300 so as to be hooked to the associated fastening hole 120 when the hook protrusion 321 is inserted into the fastening hole 120, and a slope 322 may be formed at the other side surface of the end portion 320 such that the fastening section 300 is pressed in one direction when the hook protrusion 321 is inserted into the fastening hole 120.

The other end portion 310 of the fastening section 300 preferably protrudes and extends in a direction perpendicular to the longitudinal direction of the fastening section 300 so that the housing 100 and the valve panel 200 come into contact with a circumferential portion of the other end portion 310.

As shown in FIG. 6, it is preferable that the valve panel 200 is directed toward the exterior of the vehicle and the housing 100 is arranged toward the interior of the vehicle. The fastening section 300 is preferably inserted to the outer side of the valve panel 200, namely, inserted toward the interior of the vehicle from the exterior thereof such that the end portions 320 of the fastening section 300 are penetrably coupled to the fastening holes 120 and the coupling holes 210. This enables introduction of contaminants to be prevented from the outside by means of primary sealing by the fastening section 300 and by means of secondary sealing by the sealing protrusion 220.

In addition, the slope 322 is formed such that each end portion 320 of the fastening section 300 having the slope 322 has an increasing cross-sectional area toward the other end portion 310 of the fastening section 300. Consequently, each hook protrusion 321 is pressed in a protrusion direction, namely, in one direction during insertion of the fastening section 300 so that the hook protrusion 321 may be securely coupled to the associated fastening hole 120 and sealing between the circumference of the end portion 320 of the fastening section 300 and the fastening hole 120 may be increased.

The fastening section 300 may be provided in plural numbers according to the number of coupling holes 210 and fastening holes 120. The respective fastening sections 300 may be integrally formed in such a manner that the other end portions 310 thereof are connected to each other. Of course, each fastening section 300 may also be independently provided.

Meanwhile, the groove 311 is preferably formed on at least one of a bonding surface between the other end portion 310 of the fastening section 300 and the housing 100 and a bonding surface between the other end portion 310 of the fastening section 300 and the valve panel 200.

The groove 311 is preferably provided on the other end portion 310 of the fastening section 300. This enables the area of the bonding surface to be decreased so as to generate stress concentration, thereby increasing sealing of the fastening section 300, the housing 100, and the valve panel 200.

The groove may also be formed on both of the bonding surfaces or be selectively formed on one of the bonding surfaces.

In accordance with the air extractor grille having the above-mentioned structure, it may be possible to prevent foreign substances and exhaust gas from being introduced into the gap between the housing 100 and the valve panel 200.

In addition, the valve panel 200 may be naturally opened and closed since the valve panel 200 is easily bent.

In accordance with an air extractor grille according to the exemplary embodiments of the present invention, it may be possible to prevent foreign substances and exhaust gas from being introduced into a gap between a housing and a valve panel.

In addition, the valve panel may be naturally opened and closed since the valve panel is easily bent.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air extractor grille comprising:
a housing having a plurality of vent holes and fastening holes;
a valve panel configured to cover the vent holes and have coupling holes formed at positions corresponding to the fastening holes; and
a fastening section, wherein end portions of the fastening section pass through the coupling holes and the fastening holes to be integrally coupled to the housing and the valve panel while another end portion thereof comes into contact with the housing and the valve panel at an outer side of the valve panel to cover a gap between the housing and the valve panel.

2. The air extractor grille of claim 1, wherein a space surrounded by the another end portion of the fastening section and the housing is provided between the another end portion of the fastening section and the housing, and one end of the valve panel is provided with a sealing protrusion, an outer peripheral surface of which comes into contact with an inner peripheral surface of the space while the sealing protrusion is located in the space.

3. The air extractor grille of claim 2, wherein the housing is bent in a zigzag shape to have a dent and a ridge, and the space is formed to be surrounded by the dent and the another end portion of the fastening section.

4. The air extractor grille of claim 1, wherein one end portion of the valve panel is formed with a guide groove, and a guide protrusion engaged with the guide groove is formed at a position corresponding to the guide groove in the housing.

5. The air extractor grille of claim 4, wherein an engagement portion of the guide groove and the guide protrusion is formed in a V-shape.

6. The air extractor grille of claim 1, wherein the housing is bent at a position corresponding to the another end of the valve panel to have a ridge, and another end of the valve panel is provided with a cover protrusion which protrudes to cover the ridge.

7. The air extractor grille of claim 1, wherein the coupling holes are formed at one end portion of the valve panel in a longitudinal direction thereof, and a folded groove is formed between the coupling holes and the another end portion of the valve panel in a width direction of the valve panel such that the another end portion of the valve panel is rotatable.

8. The air extractor grille of claim 1, wherein a hook protrusion is formed on one side surface of each end portion of the fastening section to be hooked to each fastening hole when the hook protrusion is inserted into the fastening hole, and a slope is formed at another side surface of the end portion such that the fastening section is pressed in one direction when the hook protrusion is inserted into the fastening hole.

9. The air extractor grille of claim 1, wherein a groove is formed on at least one of a bonding surface between the another end portion of the fastening section and the housing and a bonding surface between the another end portion of the fastening section and the valve panel.
